(19) United States
(12) Patent Application Publication
(10) Pub. No.: US 2019/0069136 A1
(43) Pub. Date: Feb. 28, 2019

(54) ELECTRONIC DEVICE AND SYSTEM

(71) Applicant: KYOCERA Corporation, Kyoto (JP)

(72) Inventor: Yuriko NOZAKI, Yokohama-shi (JP)

(21) Appl. No.: 16/114,215

(22) Filed: Aug. 28, 2018

(30) Foreign Application Priority Data
Aug. 29, 2017 (JP) 2017-164155

(51) Int. Cl. H04W 4/029; H04M 1/725; H04N 1/00; H04L 29/08

(52) U.S. Cl. CPC H04W 4/029; H04M 1/72572; H04N 2201/0084; H04L 67/18; H04N 2201/3253; H04N 1/00307

(57) ABSTRACT

An electronic device includes a communication unit, a display, and a controller. The controller is configured, if a predetermined condition is satisfied, to receive information including a captured image captured by another electronic device and latest position information on the other electronic device from the other electronic device through the communication unit, and cause the display to simultaneously display the captured image and the position information on the display.

### CROSS-REFERENCE TO RELATED APPLICATION(S)

The present application claims priority under 35 U.S.C. § 119 to Japanese Patent Application No. 2017-164155 filed on Aug. 29, 2017, entitled “ELECTRONIC DEVICE AND SYSTEM”. The content of which is incorporated by reference herein in its entirety.

### FIELD

Embodiments of the present disclosure relate to an electronic device and a system.

### BACKGROUND

Conventionally, mobile communication devices are present, each of which displays, when electronic mail including position information is received from a certain mobile communication device, a map covering the position information included in the received electronic mail and position information on the own device on a display module thereof.

### SUMMARY

It is an object of the present disclosure to at least partially solve the problems in the conventional technology.

An electronic device according to one embodiment includes a communication unit, a display, and a controller. The controller is configured, if a predetermined condition is satisfied, to receive information including a captured image captured by another electronic device and latest position information on the other electronic device from the other electronic device through the communication unit, and cause the display to simultaneously display the captured image and the position information on the display.

An electronic device according to one embodiment includes an imager, a position information acquisition unit, a communication unit, and a controller. The controller is configured, if receiving a predetermined request from another electronic device through the communication unit, to cause the imager to capture an image, and transmit information including the image and latest position information acquired by the position information acquisition unit to the other electronic device through the communication unit.

A system according to one embodiment includes a first electronic device and a second electronic device. The first electronic device is configured to transmit information including a captured image and latest position information to the second electronic device if a predetermined condition is satisfied, and the second electronic device is configured to simultaneously display the captured image and the latest position information if receiving the information including the captured image and the latest position information from the first electronic device.

The above and other objects, features, advantages and technical and industrial significance of this disclosure will be better understood by reading the following detailed description of presently preferred embodiments of the invention, when considered in connection with the accompanying drawings.

### BRIEF DESCRIPTION OF THE DRAWINGS

FIG. 1 is a view illustrating an example of an external appearance of a mobile device according to embodiments of the present disclosure;

FIG. 2 is a view illustrating an example of another external appearance of the mobile device according to the embodiments;

FIG. 3 is a view illustrating an example of a worn state of the mobile device according to the embodiments;

FIG. 4 is a diagram illustrating an example of a system configuration according to the embodiments;

FIG. 5 is a block diagram illustrating an example of a functional configuration of the mobile device according to the embodiments;

FIG. 6 is a block diagram illustrating an example of a functional configuration of another mobile device according to the embodiments;

FIG. 7 is a diagram illustrating an example of processing according to the embodiments;

FIG. 8 is a diagram illustrating an example of a display method of an image and position information according to the embodiments;

FIG. 9 is a diagram illustrating another example of the processing according to the embodiments;

FIG. 10 is a diagram illustrating another example of the display method of the image and the position information according to the embodiments;

FIG. 11 is a diagram illustrating still another example of the processing according to the embodiments;

FIG. 12 is a diagram illustrating still another example of the display method of images and position information according to the embodiments;

FIG. 13 is a diagram illustrating still another example of the display method according to the embodiments;

FIG. 14 is a diagram illustrating an outline of route guidance processing according to the embodiments;

FIG. 15 is a flowchart illustrating a flow of the route guidance processing according to the embodiments;

FIG. 16 is a diagram illustrating still another example of the display method according to the embodiments; and

FIG. 17 is a diagram illustrating still another example of the display method according to the embodiments.

### DETAILED DESCRIPTION

Embodiments according to the present application will be described in detail with reference to the drawings. In the following description, the same components will be assigned with the same reference numerals in some cases. Furthermore, the description thereof will not be repeated in some cases. The method for providing the above-mentioned position information may have room to be improved.

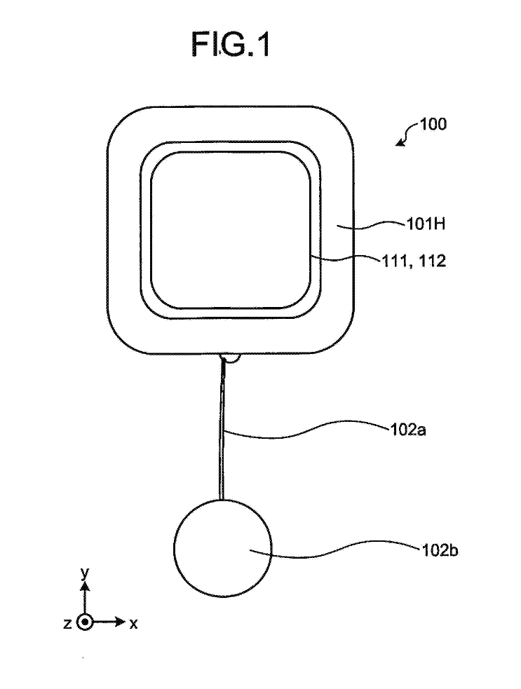

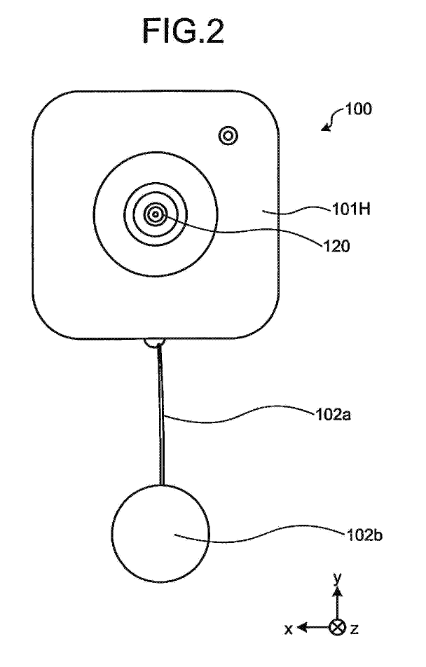

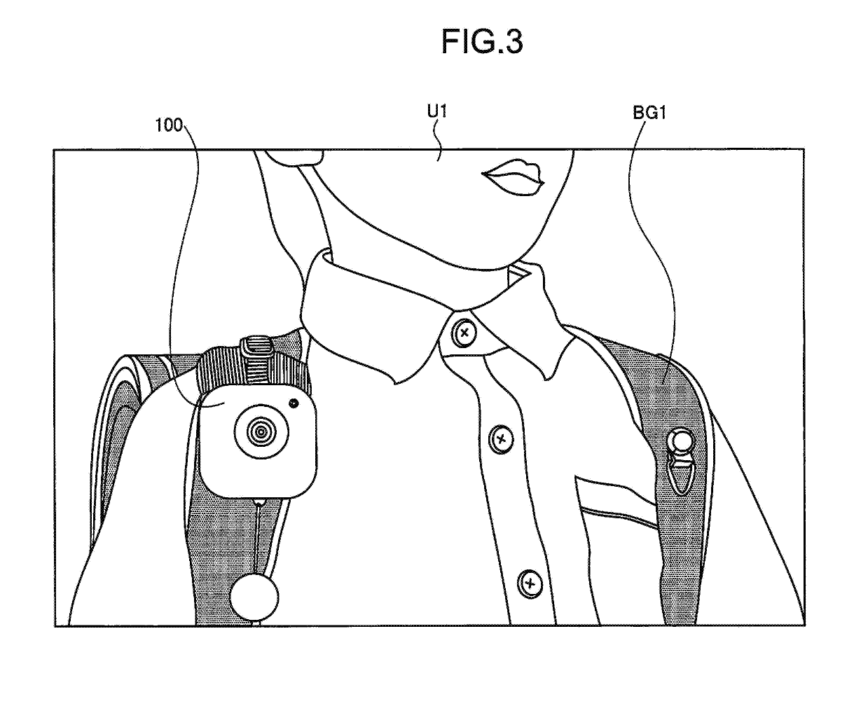

FIGS. 1 and 2 are views illustrating examples of external appearances of a mobile device according to the embodiments. FIG. 3 is a view illustrating an example of a worn state of the mobile device according to the embodiments. FIG. 1 illustrates a front surface of a mobile device 100. The front surface of the mobile device 100 is a surface that faces a user of the mobile device 100 when the user captures an image. FIG. 2 illustrates a back surface of the mobile device 100. The back surface of the mobile device 100 is a surface opposite to the front surface of the mobile device 100.

The mobile device 100 includes a body 101H, a strap 102a, a strap component 102b, a display 111, a touchscreen 112, and a camera 120. As illustrated in FIGS. 1 and 2, the body 101H has a substantially square planar shape when the mobile device 100 is viewed from the front surface side and the back surface side.

The strap 102a and the strap component 102b are physically connected together in an inseparable state. The strap 102a is physically tied to a buzzer switch 113B (to be described later) for activating a crime prevention buzzer. The strap component 102b has a disc-like structure having a certain amount of area so as to be easily pinched and operated by the user. The user can activate the crime prevention buzzer, for example, by performing a pulling operation in the negative direction of the y-axis illustrated in FIGS. 1 and 2 to operate the buzzer switch 113B.

As illustrated in FIG. 1, the display 111 and the touchscreen 112 are provided on the front surface of the body 101H. As illustrated in FIG. 2, the camera 120 is provided on the back surface of the body 101H.

Although each of the display 111 and the touchscreen 112 has a substantially square shape that is a shape similar to that of the body 101H, the shape of the display 111 and the touchscreen 112 is not limited thereto. Each of the display 111 and the touchscreen 112 can have another shape, such as a circular shape or an elliptical shape. Although the display 111 and the touchscreen 112 are disposed so as to overlap each other in the example of FIG. 1, the disposition of the display 111 and the touchscreen 112 is not limited to this example. For example, the display 111 and the touchscreen 112 may be disposed side by side, or disposed apart from each other.

As illustrated in FIG. 3, the mobile device 100 can be detachably attached to, for example, a shoulder strap portion of a bag BG1 shouldered by a user U1. The mobile device 100 is not limited to the example illustrated in FIG. 3, and may be detachably attached to, for example, clothes of the user.

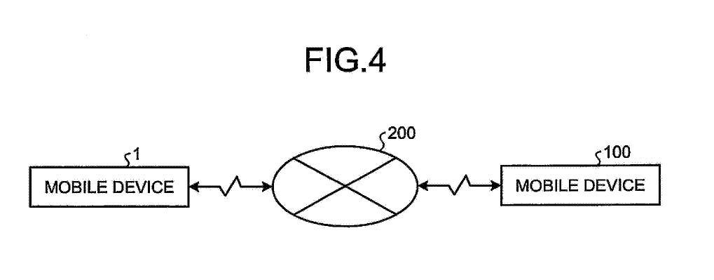

FIG. 4 is a diagram illustrating an example of a system configuration according to the embodiments. As illustrated in FIG. 4, the system according to the embodiments includes a mobile device 1 and the mobile device 100. The mobile device 1 and the mobile device 100 are connected to a network 200 in a state capable of communicating with each other. The network 200 includes the Internet and a mobile phone network. To exemplify a preferred use state of the system, a case can be considered where a child uses the mobile device 100 and each parent of the child uses the mobile device 1.

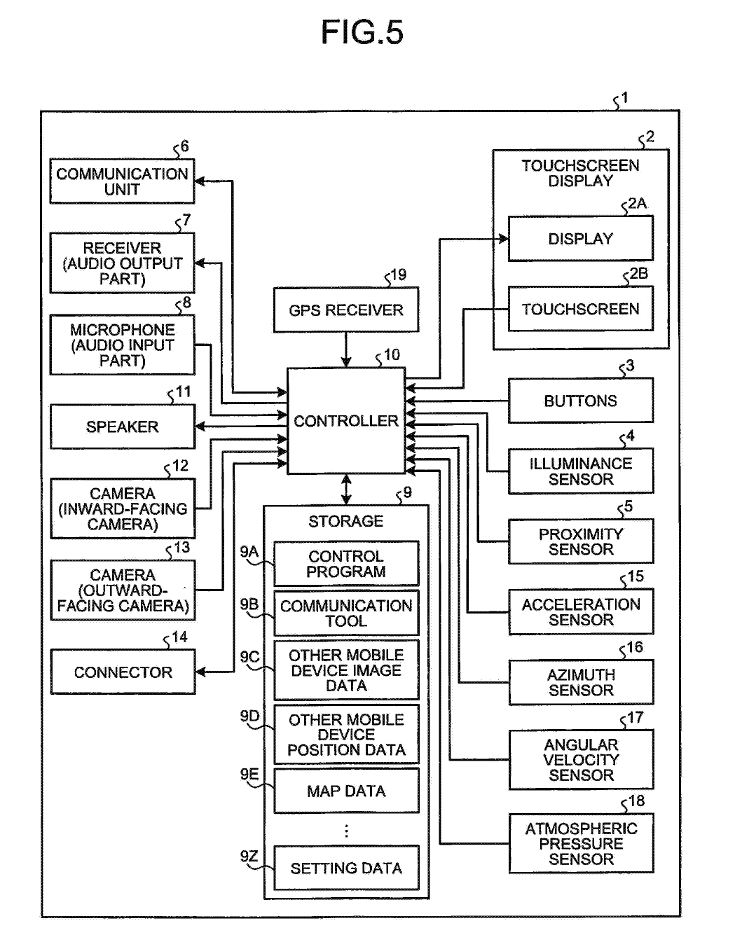

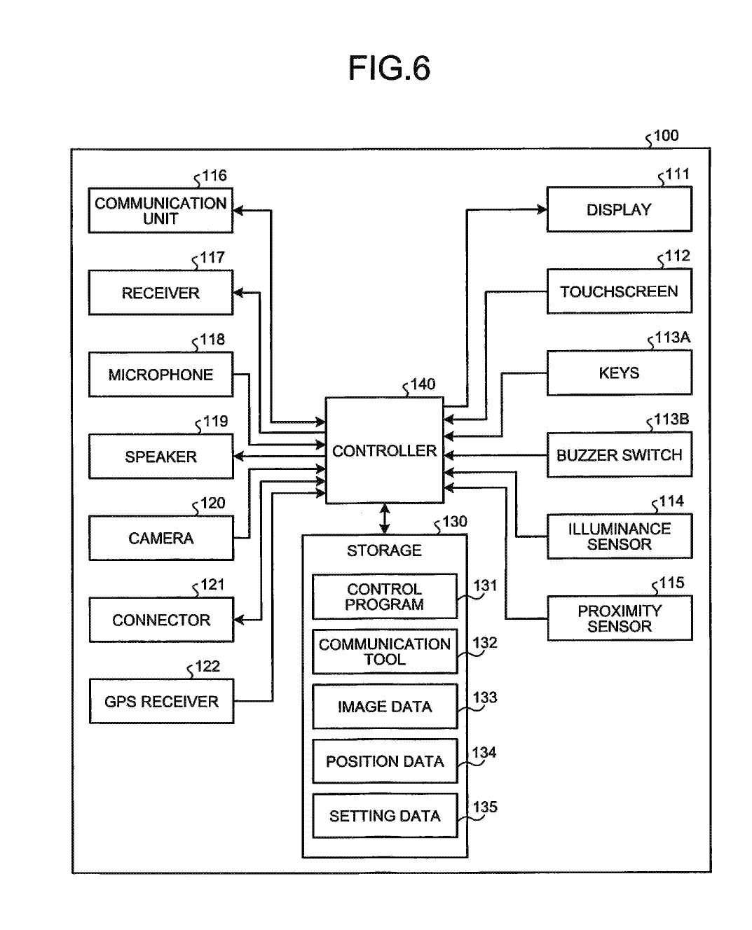

FIGS. 5 and 6 are block diagrams illustrating examples of functional configurations of the mobile devices according to the embodiments. FIG. 5 is an example of a functional configuration included in the mobile device 1 illustrated in FIG. 4. FIG. 6 is an example of a functional configuration included in the mobile device 100 illustrated in FIG. 4. In the following description, each of the mobile device 1 and the mobile device 100 will be referred to as an “own device” in some cases. In the following description, the user of each of the mobile device 1 and the mobile device 100 will be simply referred to as the “user” in some cases.

As illustrated in FIG. 5, the mobile device 1 includes a touchscreen display 2, buttons 3, an illuminance sensor 4, a proximity sensor 5, a communication unit 6, a receiver 7, a microphone 8, a storage 9, a controller 10, a speaker 11, a camera (inward-facing camera) 12, a camera (outward-facing camera) 13, a connector 14, an acceleration sensor 15, an azimuth sensor 16, an angular velocity sensor 17, an atmospheric pressure sensor 18, and a Global Positioning System (GPS) receiver 19.

The touchscreen display 2 includes a display 2A and a touchscreen 2B. The display 2A and the touchscreen 2B may be, for example, located so as to overlap each other, located side by side, or located apart from each other. If the display 2A and the touchscreen 2B are located so as to overlap each other, for example, one or a plurality of sides of the display 2A need not extend along any side of the touchscreen 2B.

The display 2A includes a display device, such as a liquid crystal display (LCD), an organic electro-luminescence display (OELD), or an inorganic electro-luminescence display (IELD). The display 2A displays objects, such as characters, images, symbols, and figures, on a screen. The screen including the objects displayed by the display 2A includes a screen called a lock screen, a screen called a home screen, and an application screen displayed while an application is in execution. The home screen may be sometimes called a desktop, a standby screen, an idle screen, a standard screen, an application list screen, or a launcher screen.

The touchscreen 2B detects contact or proximity of a finger, a pen, a stylus pen, or the like with or to the touchscreen 2B. The touchscreen 2B can detect touched positions on the touchscreen 2B when a plurality of fingers, pens, stylus pens, or the like are in contact with or in proximity to the touchscreen 2B. In the following description, positions where a plurality of fingers, pens, stylus pens, or the like detected by the touchscreen 2B are in contact with or in proximity to the touchscreen 2B are called “detection positions”. The touchscreen 2B notifies the controller 10 of the contact or proximity of the fingers with or to the touchscreen 2B, along with the detection positions. The touchscreen 2B may notify the controller 10 of the detection positions as information serving as the notification of the contact or proximity. The touchscreen display 2 including the touchscreen 2B can perform the operation performable by the touchscreen 2B. In other words, the touchscreen display 2 may perform the operation performed by the touchscreen 2B.

The controller 10 determines a type of a gesture based on at least one of the contact or proximity detected by the touchscreen 2B, the detection positions, changes in the detection positions, time during which the contact or proximity has continued, an interval at which the contact or proximity has been detected, and the number of times by which the contact has been detected. The mobile device 1 including the controller 10 can perform the operation performable by the controller 10. In other words, the mobile device 1 may perform the operation performed by the controller 10. The gesture is an operation applied to the touchscreen 2B using the fingers. The operation applied to the touchscreen 2B may be performed using the touchscreen display 2 including the touchscreen 2B. Examples of the gesture determined by the controller 10 through the touchscreen 2B include, but are not limited to, a touch, a long touch, a release, a swipe, a tap, a double tap, a long tap, a drag, a flick, a pinch-in, and a pinch-out.

The “touch” is a gesture of touching the touchscreen 2B with a finger. The mobile device 1 determines the gesture of touching the touchscreen 2B with the finger to be the touch. The “long touch” is a gesture of touching the touchscreen 2B with the finger for a time longer than a certain period of time. The mobile device 1 determines the gesture of touching the touchscreen 2B with the finger for a time longer than the certain period of time to be the long touch.

The “release” is a gesture of removing the finger from the touchscreen 2B. The mobile device 1 determines the gesture of removing the finger from the touchscreen 2B to be the release. The “swipe” is a gesture of moving the finger while keeping the finger in contact with the touchscreen 2B. The mobile device 1 determines the gesture of moving the finger while keeping the finger in contact with the touchscreen 2B to be the swipe.

The “tap” is a gesture of performing the release subsequent to the touch. The mobile device 1 determines the gesture of performing the release subsequent to the touch to be the tap. The “double tap” is a gesture of successively performing the gesture of the touch and the subsequent release twice. The mobile device 1 determines the gesture of successively performing the gesture of the touch and the subsequent release twice to be the double tap.

The “long tap” is a gesture of performing the release subsequent to the long touch. The mobile device 1 determines the gesture of performing the release subsequent to the long touch to be the long tap. The “drag” is a gesture of performing the swipe starting from an area where a movable object is displayed. The mobile device 1 determines the gesture of performing the swipe starting from the area where the movable object is displayed to be the drag.

The “flick” is a gesture of touching the touchscreen 2B with the finger and then removing the finger from the touchscreen 2B while moving the finger therealong. In other words, the “flick” is a gesture of releasing the finger while moving the finger subsequently to the touch. The mobile device 1 determines the gesture of touching the touchscreen 2B with the finger and then removing the finger from the touchscreen 2B while moving the finger therealong to be the flick. The flick is often performed while the finger is moved in one direction. The flick includes, for example, an “up flick” of moving the finger upward on the screen, a “down flick” of moving the finger downward on the screen, a “right flick” of moving the finger rightward on the screen, and a “left flick” of moving the finger leftward on the screen. The finger is often moved quicker in the flick than in the swipe.

The “pinch-in” is a gesture of swiping a plurality of fingers in directions moving closer to one another. The mobile device 1 determines a gesture of reducing a distance between a position of one finger and a position of another finger detected by the touchscreen 2B to be the pinch-in. The “pinch-out” is a gesture of swiping a plurality of fingers in directions moving away from one another. The mobile device 1 determines a gesture of increasing a distance between a position of one finger and a position of another finger detected by the touchscreen 2B to be the pinch-out.

In the following description, in some cases, a gesture performed with one finger will be called a “single touch gesture”, and a gesture performed with two or more fingers will be called a “multi-touch gesture”. The multi-touch gesture includes, for example, the pinch-in and the pinch-out. For example, the tap, the flick, and the swipe are single touch gestures if performed with one finger, or multi-touch gestures if performed with two or more fingers.

The controller 10 operates according to these gestures determined through the touchscreen 2B. Thus, intuitive and easy-to-use operability is achieved for the user. The operation performed by the controller 10 according to the determined gesture may vary depending on the screen displayed on the display 2A.

The detection method of the touchscreen 2B may be any method, such as a capacitance method, a resistive film method, a surface acoustic wave method, an infrared method, or a load detection method.

The buttons 3 receive operation inputs from the user. The number of buttons 3 may be any number. The controller 10 cooperates with the buttons 3 to detect operations to the buttons 3. Examples of the operations to the buttons 3 include, but are not limited to, a click, a double click, a triple click, a push, and a multi-push. The buttons 3 may be assigned with various functions of, for example, a home button, a back button, a menu button, a power-on button and a power-off button (power button), a sleep button, and a wake button.

The illuminance sensor 4 detects illuminance. The illuminance is a value of a luminous flux incident on a unit area of a measuring surface of the illuminance sensor 4. The illuminance sensor 4 is used, for example, for adjusting the luminance of the display 2A.

The proximity sensor 5 detects presence of a nearby object in a non-contact manner. The proximity sensor 5 includes a light-emitting element for emitting infrared rays and a light receiving element for receiving reflected light of the infrared rays emitted from the light-emitting element. The illuminance sensor 4 and the proximity sensor 5 may be configured as one sensor.

The communication unit 6 performs wireless communication. Examples of wireless communication standards supported by the communication unit 6 include communication standards for cellular phones, such as 2G, 3G, 4G, and 5G, and short-range wireless communication standards. Examples of the communication standards for cellular phones include Long Term Evolution (LTE), Wideband Code Division Multiple Access (W-CDMA) (registered trademark), CDMA 2000, Personal Digital Cellular (PDC), Global System for Mobile Communications (GSM) (registered trademark), and Personal Handy-phone System (PHS). Examples of the short-range wireless communication standards include Worldwide Interoperability for Microwave Access (WiMAX) (registered trademark), IEEE 802.11, Bluetooth (registered trademark), Infrared Data Association (IrDA) standard, the Near Field Communication (NFC) (registered trademark), and Wireless Personal Area Network (WPAN). The communication unit 6 may support one or more of the communication standards listed above. The communication unit 6 is an example of a “communication module”.

The receiver 7 outputs a sound signal transmitted from the controller 10 as sound. The microphone 8 converts, for example, an input voice of the user into a sound signal, and transmits the sound signal to the controller 10.

The storage 9 stores therein programs and data. The storage 9 may be used as a work area for temporarily storing therein processing results of the controller 10. The storage 9 may include any non-transitory storage medium, such as a semiconductor storage medium or a magnetic storage medium. The storage 9 may include a plurality of types of storage media. The storage 9 may include a combination of a storage medium, such as a memory card, an optical disc, or a magneto-optical disk, with a reading device of the storage medium. The storage 9 may include a storage device, such as a random access memory (RAM), that is used as a temporary storage area.

The programs stored in the storage 9 include applications to be executed in the foreground or the background, and a support program (not illustrated) that supports operations of the applications. For example, when executed in the foreground, the applications display screens related to the applications on the display 2A. Examples of the support program include an operating system (OS). The programs may be installed into the storage 9 through the wireless communication by the communication unit 6 or via a non-transitory storage medium.

The storage 9 can store therein, for example, a control program 9A, a communication tool 9B, other mobile device image data 9C, other mobile device position data 9D, map data 9E, and setting data 9Z.

The control program 9A can provide functions for performing processing related to various operations of the mobile device 1. The functions provided by the control program 9A include a function to adjust the luminance of the display 2A based on a detection result of the illuminance sensor 4. The functions provided by the control program 9A also include a function to invalidate operations to the touchscreen 2B based on a detection result of the proximity sensor 5. The functions provided by the control program 9A also include a function to provide telephone communication by controlling, for example, the communication unit 6, the receiver 7, and the microphone 8. The functions provided by the control program 9A also include a function to control the imaging processing of the camera 12 and the camera 13. The functions provided by the control program 9A also include a function to control communication with external equipment connected through the connector 14. The functions provided by the control program 9A also include a function to perform various types of control, such as changing information displayed on the display 2A in response to a gesture determined based on a detection result of the touchscreen 2B. The functions provided by the control program 9A also include a function to detect, for example, movements and stops of the user carrying the mobile device 1 based on a detection result of the acceleration sensor 15. The functions provided by the control program 9A also include a function to perform processing based on the current position, based on signals acquired from the GPS receiver 19.

The control program 9A can provide a function for receiving, if a predetermined condition including condition 1 or condition 2 is satisfied, information including an image captured by the mobile device 100 (hereinafter, referred to as a “captured image”) and the latest position information on the mobile device 100, from the mobile device 100 through the communication unit 6, and simultaneously displaying the captured image and the position information on the display 2A. Condition 1 includes that a predetermined request is transmitted to the mobile device 100 through the communication unit 6, and the mobile device 100 captures an image in response to the request. Condition 2 includes that a predetermined operation is performed on the mobile device 100, and the mobile device 100 captures an image in response to the operation. The predetermined condition may be such that a physical key provided for executing the above-described function is pressed down, or such that a predetermined operation for executing the above-described function is applied to the touchscreen 2B. In an embodiment, the latest position information on the mobile device 100 may be position information, among pieces of position information acquired by the mobile device 100 at times when the above-described predetermined condition was satisfied, that has been acquired at the nearest time to the time when the predetermined condition was satisfied. In another embodiment, the latest position information on the mobile device 100 may be position information acquired by the mobile device 100 using the satisfaction of a predetermined condition including condition 1 and condition 2 as a trigger. In still another embodiment, the latest position information on the mobile device 100 may be position information on the mobile device 100 at the instant when the predetermined condition including condition 1 and condition 2 is satisfied.

The captured image simultaneously displayed together with the position information on the display 2A by the function provided by the control program 9A includes a still image or a moving image. The still image or the moving image may be a captured image stored in the mobile device 100. The moving image may be displayed on the display 2A by transmitting the image captured by the mobile device 100 from the mobile device 100 to the mobile device 1 in real time. In other words, the mobile device 100 may continuously transmit the captured image to the mobile device 1 on a packet-by-packet basis each time the image is captured. In this case, the moving image displayed on the display 2A may be the same image as a live view image displayed on a camera interface of the mobile device 100. The live view image is also called a through image or a preview image.

The control program 9A can provide a function for repeatedly receiving the image captured by the mobile device 100 and the position information thereon a plurality of times at predetermined intervals of time, and simultaneously displaying the received captured image and position information on the display 2A each time the captured image and the position information are received. In other words, the control program 9A can update the image and the position information being displayed on the display 2A to the latest information based on the image and the position information repeatedly received from the mobile device 100.

The control program 9A can provide a function for displaying the captured image and the position information received from the mobile device 100 in a manner superimposed on a map including a position corresponding to the position information on the mobile device 100.

The control program 9A can provide a dedicated user interface for performing the processing of simultaneously displaying the image captured by the mobile device 100 and the position information thereon on the display 2A by satisfying the above-described predetermined condition. For example, the control program 9A can start the dedicated user interface, and, if the above-described predetermined condition is satisfied, can simultaneously load the image captured by the mobile device 100 and the position information thereon onto the user interface. However, the simultaneous display is not limited to using the dedicated user interface. The image captured by the mobile device 100 and the position information thereon may be simultaneously displayed in a display environment provided by another application, such as a certain browser or a map application.

The communication tool 9B can provide a function for exchanging messages and images with another mobile device (such as the mobile device 100). The communication tool 9B is a messaging application that operates on the mobile device 1. The communication tool 9B can display an execution screen of the communication tool 9B on the display 2A. The communication tool 9B can display, for example, the messages and the images exchanged with the other mobile device on the display 2A. The communication tool 9B can perform processing in response to an operation to the execution screen based on the detection result of the touchscreen 2B.

The other mobile device image data 9C is data of images captured by the user on the mobile device 100. The other mobile device image data 9C includes still images or moving images. The moving images include the live view image displayed on the camera interface of the mobile device 100. The other mobile device image data 9C may be data compressed by a predetermined codec or raw data.

The other mobile device position data 9D is data of the position information on the mobile device 100 measured on the mobile device 100.

The map data 9E is data for displaying a map based on the position information.

The setting data 9Z includes information on various settings concerning operations of the mobile device 1. The setting data 9Z may include data, such as a phone number and an e-mail address, of the mobile device 100.

The mobile device 1 may cooperate with a cloud storage through the communication unit 6 to access files and data stored in the cloud storage. The cloud storage may store a part or the whole of the programs and the data stored in the storage 9.

The controller 10 includes an arithmetic processing unit. Examples of the arithmetic processing unit include, but are not limited to, a central processing unit (CPU), a system-on-a-chip (SoC), a microcontroller unit (MCU), a field-programmable gate array (FPGA), and a coprocessor. The controller 10 integrally controls the operations of the mobile device 1 to perform various functions.

Specifically, the controller 10 executes commands included in the programs stored in the storage 9 while referring to the data stored in the storage 9 as needed. The controller 10 controls functional modules according to the data and the commands to thereby perform the various functions. Examples of the functional modules include, but are not limited to, the display 2A, the communication unit 6, the microphone 8, the speaker 11, and the GPS receiver 19. The controller 10 changes the control according to detection results of detectors in some cases. The detectors include, but are not limited to, the touchscreen 2B, the buttons 3, the illuminance sensor 4, the proximity sensor 5, the microphone 8, the camera 12, the camera 13, the acceleration sensor 15, the azimuth sensor 16, the angular velocity sensor 17, and the atmospheric pressure sensor 18.

The controller 10 can perform various types of control related to the operations of the own device by executing the control program 9A. The controller 10 can perform, for example, the processing of adjusting the luminance of the display 2A based on the detection result of the illuminance sensor 4. The controller 10 can perform, for example, the processing of invalidating the operations to the touchscreen 2B based on the detection result of the proximity sensor 5. The controller 10 can perform, for example, the processing of providing the telephone communication by controlling the communication unit 6, the receiver 7, and the microphone 8. The controller 10 can perform, for example, the processing of controlling the imaging processing of the camera 12 and the camera 13. The controller 10 can perform, for example, the processing of controlling the communication with the external equipment connected through the connector 14. The controller 10 can perform, for example, the processing of performing the various types of control, such as changing information displayed on the display 2A in response to a gesture determined based on the detection result of the touchscreen 2B. The controller 10 can perform, for example, the processing of detecting, for example, the movements and stops of the user carrying the own device based on the detection result of the acceleration sensor 15. The controller 10 can perform, for example, the processing based on the current position, based on the signals acquired from the GPS receiver 19.

By executing the control program 9A, the controller 10 can perform the processing of receiving, if condition 1 or condition 2 is satisfied, information including an image captured by the mobile device 100 and the latest position information on the mobile device 100 from the mobile device 100 through the communication unit 6, and simultaneously displaying the captured image and the position information on the display 2A.

By executing the control program 9A, the controller 10 can perform the processing of repeatedly receiving the image captured by the mobile device 100 and the position information thereon a plurality of times at predetermined intervals of time, and simultaneously displaying the received captured image and position information on the display 2A each time the captured image and the position are received.

By executing the control program 9A, the controller 10 can perform the processing of displaying the captured image and the position information received from the mobile device 100 in a manner superimposed on a map including a position corresponding to the position information received from the mobile device 100.

By executing the control program 9A and the communication tool 9B, the controller 10 can perform the processing of displaying the captured image and the position information displayed overlapping the map including the position corresponding to the position information, each as an independent massage, on the execution screen of the communication tool 9B displayed on the display 2A.

By executing the control program 9A and the communication tool 9B, the controller 10 can perform the processing for exchanging messages and images with the other mobile device (such as the mobile device 100).

The speaker 11 outputs a sound signal transmitted from the controller 10 as sound. The speaker 11 is used to output, for example, ringtones and music. One of the receiver 7 and the speaker 11 may also perform the function of the other one.

The camera 12 and the camera 13 perform the imaging processing of converting an image captured by the user into an electrical signal and recording the electrical signal. The camera 12 is an inward-facing camera that records an image of an object facing the display 2A. The camera 13 is an outward-facing camera that records an image of an object facing a surface opposite to the display 2A. The camera 12 and the camera 13 may be mounted on the mobile device 1 in a state of being functionally and physically integrated as a camera unit that can be used by being switched between the inward-facing camera and the outward-facing camera. The camera 12 and the camera 13 are examples of an “imager”.

The connector 14 is a terminal to which other equipment is connected. The connector 14 may be a general purpose terminal, such as a Universal Serial Bus (USB), a High-Definition Multimedia Interface (HDMI) (registered trademark), a Mobile High-definition Link (MHL), Light Peak, Thunderbolt (registered trademark), a local area network (LAN) connector or an earphone-microphone connector. The connector 14 may be a specially designed terminal, such as a dock connector. Examples of the other equipment connected to the connector 14 include, but are not limited to, a flying object, a charger, an external storage, a speaker, a communication device, and an information processing device.

The acceleration sensor 15 can detect the direction and the magnitude of an acceleration acting on the mobile device 1. As one example of the embodiments, the acceleration sensor 15 of a triaxial type can be employed that detects the acceleration in the X-axis direction, the Y-axis direction, and the Z-axis direction. The acceleration sensor 15 can be configured as a piezoresistive sensor, a capacitive sensor, a piezoelectric element (piezoelectric) sensor, a thermal microelectromechanical systems (MEMS) sensor, a servo sensor in which an operated moving coil is returned by a feedback current, or a strain gauge sensor. The acceleration sensor 15 transmits the detection result to the controller 10. The controller 10 can perform various types of control based on the detection result of the acceleration sensor 15. For example, when a gravitational force acting on the mobile device 1 is output as the acceleration from the acceleration sensor 15, the controller 10 can perform control reflecting the direction of the gravitational force acting on the mobile device 1.

The azimuth sensor 16 can detect the orientation of the Earth's magnetic field. The azimuth sensor 16 transmits the detection result to the controller 10. The controller 10 can perform various types of control based on the detection result of the azimuth sensor 16. For example, the controller 10 can identify the orientation (azimuth) of the mobile device 1 based on the orientation of the Earth's magnetic field, and perform control reflecting the identified azimuth of the mobile device 1.

The angular velocity sensor 17 can detect the angular velocity of the mobile device 1. The angular velocity sensor 17 transmits the detection result to the controller 10. The controller 10 can perform various types of control based on the detection result of the angular velocity sensor 17. For example, the controller 10 can perform control reflecting a rotation of the mobile device 1 based on whether an angular velocity is output from the angular velocity sensor 17.

The controller 10 is not limited to the case where the detection results of the acceleration sensor 15, the azimuth sensor 16, and the angular velocity sensor 17 are individually used, and can use the detection results in combination with one another.

The atmospheric pressure sensor 18 can detect an atmospheric pressure acting on the mobile device 1. The detection result of the atmospheric pressure sensor 18 may include an atmospheric pressure variation per unit time. The atmospheric pressure variation may be an absolute value or a value obtained by accumulating scalar quantities. The unit time may be set to any period of time. The atmospheric pressure sensor 18 transmits the detection result to the controller 10.

The GPS receiver 19 can receive a radio signal in a predetermined frequency band from a GPS satellite. The GPS receiver 19 demodulates the received radio signal, and transmits the demodulated signal to the controller 10. The GPS receiver 19 is an example of a “position information acquisition unit”.

The mobile device 1 may include a vibrator. The vibrator vibrates a part or the whole of the mobile device 1. To generate the vibration, the vibrator includes, for example, a piezoelectric element or an eccentric motor. The mobile device 1 may include, for example, a temperature sensor, a humidity sensor, and a pressure sensor in addition to the above-described sensors. The mobile device 1 is equipped with the functional modules, such as a battery, naturally used to maintain the functions of the mobile device 1, and with the detectors naturally used to perform the control of the mobile device 1.

As illustrated in FIG. 6, the mobile device 100 includes the display 111, the touchscreen 112, keys 113A, the buzzer switch 113B, an illuminance sensor 114, a proximity sensor 115, a communication unit 116, a receiver 117, a microphone 118, a speaker 119, the camera 120, a connector 121, a GPS receiver 122, a storage 130, and a controller 140.

The display 111 includes a display device, such as a liquid crystal display (LCD), an organic electro-luminescence display (OELD), or an inorganic electro-luminescence display (IELD). The display 111 displays objects, such as characters, images, symbols, and figures, on a screen. The screen including the objects displayed by the display 111 includes, for example, a screen called a lock screen, a screen called a home screen, and an application screen displayed while an application is in execution. The home screen may be sometimes called a desktop, a standby screen, an idle screen, a standard screen, an application list screen, or a launcher screen.

The touchscreen 112 detects contact or proximity of a finger, a pen, a stylus pen, or the like with or to the touchscreen 112. The touchscreen 112 can detect touched positions on the touchscreen 112 when a plurality of fingers, pens, stylus pens, or the like are in contact with or in proximity to the touchscreen 112. In the following description, positions where a plurality of fingers, pens, stylus pens, or the like detected by the touchscreen 112 are in contact with or in proximity to the touchscreen 112 are called “detection positions”. The touchscreen 112 notifies the controller 140 of the contact or proximity of the fingers with or to the touchscreen 112, along with the detection positions. The touchscreen 112 may notify the controller 140 of the detection positions as information serving as the notification of the contact or proximity.

The controller 140 determines a type of a gesture based on at least one of the contact or proximity detected by the touchscreen 112, the detection positions, changes in the detection positions, time during which the contact or proximity has continued, an interval at which the contact or proximity has been detected, and the number of times by which the contact has been detected. The gesture is an operation applied to the touchscreen 112 using the fingers. Examples of the gesture determined by the controller 140 through the touchscreen 112 include, but are not limited to, a touch, a long touch, a release, a swipe, a tap, a double tap, a long tap, a drag, a flick, a pinch-in, and a pinch-out.

The “touch” is a gesture of touching the touchscreen 112 with a finger. The mobile device 100 determines the gesture of touching the touchscreen 112 with the finger to be the touch. The “long touch” is a gesture of touching the touchscreen 112 with the finger for a time longer than a certain period of time. The mobile device 100 determines the gesture of touching the touchscreen 112 with the finger for a time longer than the certain period of time to be the long touch.

The “release” is a gesture of removing the finger from the touchscreen 112. The mobile device 100 determines the gesture of removing the finger from the touchscreen 112 to be the release. The “swipe” is a gesture of moving the finger while keeping the finger in contact with the touchscreen 112. The mobile device 100 determines the gesture of moving the finger while keeping the finger in contact with the touchscreen 112 to be the swipe.

The “tap” is a gesture of performing the release subsequent to the touch. The mobile device 100 determines the gesture of performing the release subsequent to the touch to be the tap. The “double tap” is a gesture of successively performing the gesture of the touch and the subsequent release twice. The mobile device 100 determines the gesture of successively performing the gesture of the touch and the subsequent release twice to be the double tap.

The “long tap” is a gesture of performing the release subsequent to the long touch. The mobile device 100 determines the gesture of performing the release subsequent to the long touch to be the long tap. The “drag” is a gesture of performing the swipe starting from an area where a movable object is displayed. The mobile device 100 determines the gesture of performing the swipe starting from the area where the movable object is displayed to be the drag.

The “flick” is a gesture of touching the touchscreen 112 with the finger and then removing the finger from the touchscreen 112 while moving the finger therealong. In other words, the “flick” is a gesture of releasing the finger while moving the finger subsequently to the touch. The mobile device 100 determines the gesture of touching the touchscreen 112 with the finger and then removing the finger from the touchscreen 112 while moving the finger therealong to be the flick. The flick is often performed while the finger is moved in one direction. The flick includes, for example, an “up flick” of moving the finger upward on the screen, a “down flick” of moving the finger downward on the screen, a “right flick” of moving the finger rightward on the screen, and a “left flick” of moving the finger leftward on the screen. The finger is often moved quicker in the flick than in the swipe.

The “pinch-in” is a gesture of swiping a plurality of fingers in directions moving closer to one another. The mobile device 100 determines a gesture of reducing a distance between a position of one finger and a position of another finger detected by the touchscreen 112 to be the pinch-in. The “pinch-out” is a gesture of swiping a plurality of fingers in directions moving away from one another. The mobile device 100 determines a gesture of increasing a distance between a position of one finger and a position of another finger detected by the touchscreen 112 to be the pinch-out.

In the following description, in some cases, a gesture performed with one finger will be called a “single touch gesture”, and a gesture performed with two or more fingers will be called a “multi-touch gesture”. The multi-touch gesture includes, for example, the pinch-in and the pinch-out. For example, the tap, the flick, and the swipe are single touch gestures if performed with one finger, or multi-touch gestures if performed with two or more fingers.

The controller 140 operates according to these gestures determined through the touchscreen 112. Thus, the intuitive and easy-to-use operability is achieved for the user. The operation performed by the controller 140 according to the determined gesture may vary depending on the screen displayed on the display 111.

The detection method of the touchscreen 112 may be any method, such as the capacitance method, the resistive film method, the surface acoustic wave method, the infrared method, or the load detection method.

The keys 113A receive operation inputs from the user. The keys 113A may be assigned with various commands, for example, to turn the power on and to display a screen. The mobile device 100 may include a plurality of keys related to functions provided by the mobile device 100, in addition to the keys 113A illustrated in FIG. 6. Examples of the operations to the keys 113A include, but are not limited to, a click, a double click, a triple click, a push, and a multi-push.

The buzzer switch 113B receives an operation to activate a crime prevention buzzer. When the buzzer switch 113B is pulled by the user, a signal instructing sounding of an audible alarm is output from a circuit connected to the buzzer switch 113B to the controller 140. The buzzer switch 113B is an example of an “operation part”.

The illuminance sensor 114 detects illuminance. The illuminance is a value of a luminous flux incident on a unit area of a measuring surface of the illuminance sensor 114. The illuminance sensor 114 is used, for example, for adjusting the luminance of the display 111.

The proximity sensor 115 detects presence of a nearby object in a non-contact manner. The proximity sensor 115 includes a light-emitting element for emitting infrared rays and a light receiving element for receiving reflected light of the infrared rays emitted from the light-emitting element. The illuminance sensor 114 and the proximity sensor 115 may be configured as one sensor.

The communication unit 116 performs wireless communication. Examples of wireless communication standards supported by the communication unit 116 include communication standards for cellular phones, such as 2G, 3G, 4G, and 5G, and short-range wireless communication standards. Examples of the communication standards for cellular phones include Long Term Evolution (LTE), Wideband Code Division Multiple Access (W-CDMA) (registered trademark), CDMA 2000, Personal Digital Cellular (PDC), Global System for Mobile Communications (GSM) (registered trademark), and Personal Handy-phone System (PHS). Examples of the short-range wireless communication standards include Worldwide Interoperability for Microwave Access (WiMAX) (registered trademark), IEEE 802.11, Bluetooth (registered trademark), Infrared Data Association (IrDA), Near Field Communication (NFC) (registered trademark), and Wireless Personal Area Network (WPAN). The communication unit 116 may support one or more of the communication standards listed above. The communication unit 116 is an example of the “communication module”.

The receiver 117 outputs a sound signal transmitted from the controller 140 as sound. The microphone 118 converts, for example, an input voice of the user into a sound signal, and transmits the sound signal to the controller 140.

The speaker 119 outputs a sound signal transmitted from the controller 140 as sound. The speaker 119 is used to output, for example, a warning sound. One of the receiver 117 and the speaker 119 may also perform the function of the other one. The speaker 119 is an example of an “audio output part”.

The camera 120 performs the imaging processing of converting an image captured by the user into an electrical signal and recording the electrical signal. The camera 120 records an image of an object facing the back surface of the body 101H of the mobile device 100. The images recorded by the camera 120 include still images and moving images. The moving images include the live view image displayed on the camera interface. The images recorded by the camera 120 may be data compressed by the predetermined codec or raw data. The camera 120 is an example of the “imager”.

The connector 121 is a terminal to which other equipment is connected. The connector 121 may be a general purpose terminal, such as a Universal Serial Bus (USB), a High-Definition Multimedia Interface (HDMI) (registered trademark), a Mobile High-definition Link (MHL), Light Peak, Thunderbolt (registered trademark), a local area network (LAN) connector or an earphone-microphone connector. The connector 121 may be a specially designed terminal, such as a dock connector. Examples of the other equipment connected to the connector 121 include, but are not limited to, a charger, an external storage, a speaker, a communication device, and an information processing device.

The GPS receiver 122 can receive a radio signal in a predetermined frequency band from a GPS satellite. The GPS receiver 122 demodulates the received radio signal, and transmits the demodulated signal to the controller 140.

The storage 130 stores therein programs and data. The storage 130 may be used as a work area for temporarily storing processing results of the controller 140. The storage 130 may include any non-transitory storage medium, such as a semiconductor storage medium or a magnetic storage medium. The storage 130 may include a plurality of types of storage media. The storage 130 may include a combination of a storage medium, such as a memory card, an optical disc, or a magneto-optical disk, with a reading device of the storage medium. The storage 130 may include a storage device, such as a random access memory (RAM), that is used as a temporary storage area.

The programs stored in the storage 130 include applications to be executed in the foreground or the background, and a support program (not illustrated) that supports operations of the applications. For example, when executed in the foreground, the applications display screens related to the applications on the display 111. Examples of the support program include an operating system (OS). The programs may be installed into the storage 130 through the wireless communication by the communication unit 116 or via a non-transitory storage medium.

The storage 130 can store therein, for example, a control program 131, a communication tool 132, image data 133, position data 134, and setting data 135.

The control program 131 can provide functions for performing processing related to various operations of the mobile device 100. The functions provided by the control program 131 include a function to adjust the luminance of the display 111 based on a detection result of the illuminance sensor 114. The functions provided by the control program 131 also include a function to invalidate operations to the touchscreen 112 based on a detection result of the proximity sensor 115. The functions provided by the control program 131 also include a function to provide telephone communication by controlling, for example, the communication unit 116, the receiver 117, and the microphone 118. The functions provided by the control program 131 also include a function to control the imaging processing of the camera 120. The functions provided by the control program 131 also include a function to control communication with external equipment connected through the connector 121. The functions provided by the control program 131 also include a function to perform various types of control, such as changing information displayed on the display 111 in response to a gesture determined based on a detection result of the touchscreen 112. The functions provided by the control program 131 also include a function to perform processing based on the current position based on a signal acquired from the GPS receiver 122.

The control program 131 can provide a function for outputting the warning sound from the speaker 119 if the signal instructing the output of the audible alarm is received from the circuit connected to the buzzer switch 113B. The control program 131 can provide a function for causing the camera 120 to capture an image and transmitting information including the image captured by the camera 120 and the latest position information acquired by the GPS receiver 122 to the mobile device 1 through the communication unit 116 after the signal instructing the output of the audible alarm is received from the circuit connected to the buzzer switch 113B.

The control program 131 can provide a function for causing the camera 120 to perform the imaging processing and transmitting the information including the image recorded by the camera 120 and the latest position information acquired by the GPS receiver 122 to the mobile device 1 through the communication unit 116 if a predetermined request is received from the other electronic device through the communication unit 116.

The control program 131 can provide a function for transmitting the image recorded by the camera 120 as an image smaller in difference in ratio between vertical and horizontal sizes (aspect ratio) than that of the display 2A included in the mobile device 1.

The communication tool 132 can provide a function for exchanging messages and images with another mobile device (such as the mobile device 1). The communication tool 132 is a messaging application that operates on the mobile device 100. The communication tool 132 can display an execution screen of the communication tool 132 on the display 111. The communication tool 132 can display, for example, the messages and the images exchanged with the other mobile device on the display 111. The communication tool 132 can perform processing in response to an operation to the execution screen based on the detection result of the touchscreen 112.

The image data 133 is data of images recorded by the imaging processing of the camera 120.

The position data 134 is data indicating the position of the own device positioned based on a signal acquired from the GPS receiver 122.

The setting data 135 includes information on various settings concerning operations of the mobile device 100. The setting data 135 may include data, such as a phone number and an e-mail address, of the mobile device 1.

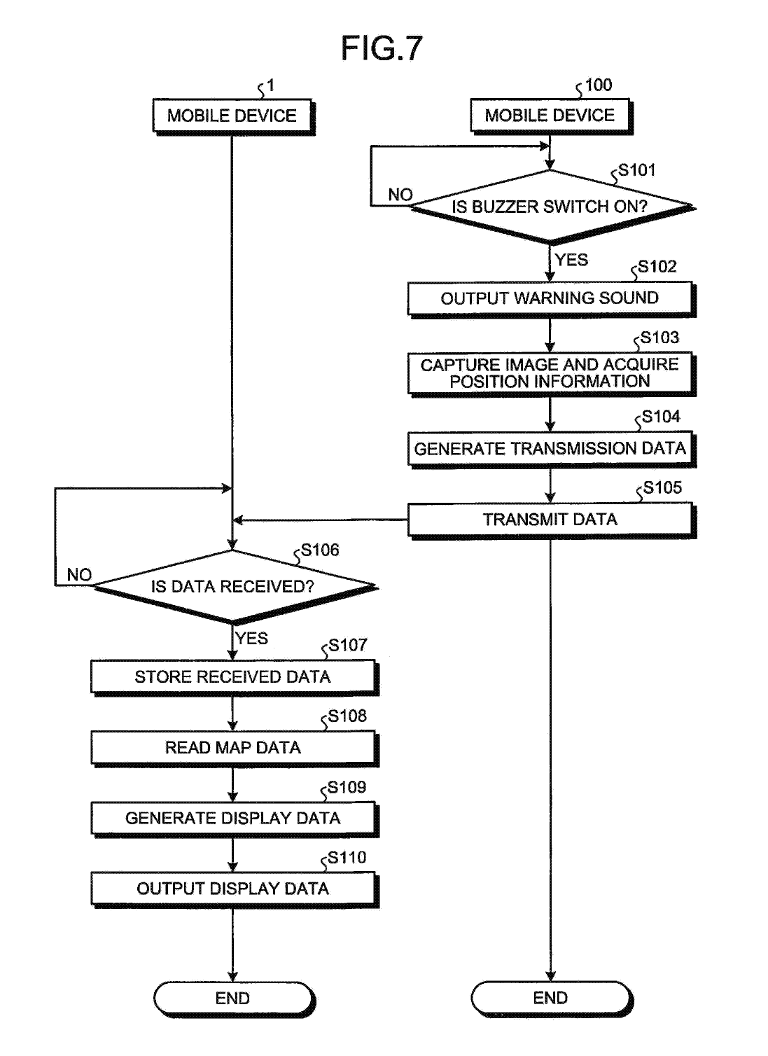

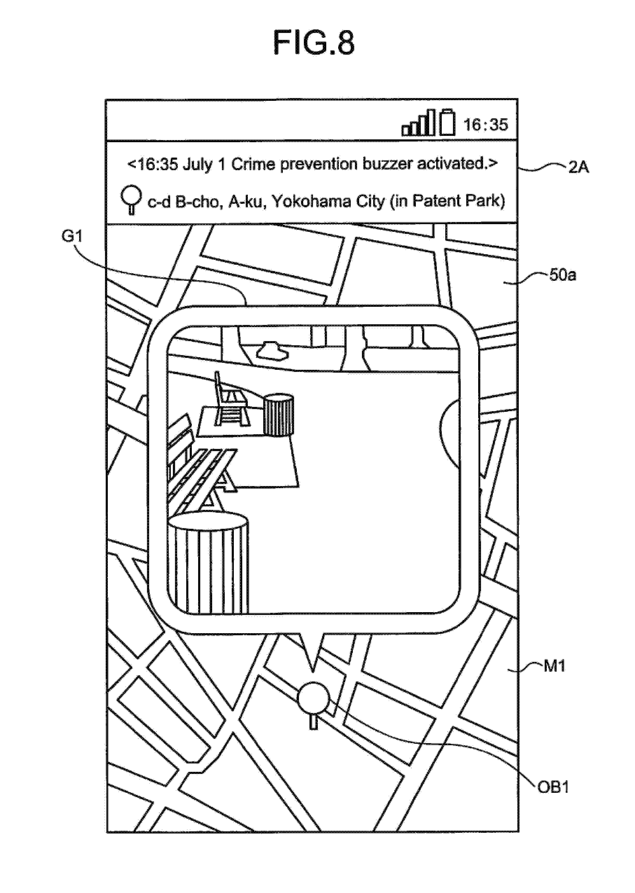

An example of processing according to the embodiments will be described using FIGS. 7 and 8. FIG. 7 is a diagram illustrating the example of the processing according to the embodiments. FIG. 8 is a diagram illustrating an example of a display method of the image and the position information according to the embodiments. The processing illustrated in FIG. 7 is an example of processing performed between the mobile device 100 and the mobile device 1 using the activation of the buzzer switch 113B in the mobile device 100 as a trigger.

As illustrated in FIG. 7, the mobile device 100 determines whether the buzzer switch 113B is operated (Step S101).

If, as a result of the determination, it is determined that the buzzer switch 113B is operated (Yes at Step S101), the mobile device 100 outputs the warning sound from the speaker 119 (Step S102).

Subsequent to the output of the warning sound, the mobile device 100 captures an image and acquires position information (Step S103), and generates transmission data including the image data and the position information (Step S104).

The mobile device 100 transmits the transmission data generated at Step S104 to the mobile device 1 (Step S105), and ends the processing.

The mobile device 1 determines whether the data is received from the mobile device 100 (Step S106).

If, as a result of the determination, it is determined that the data is received from the mobile device 100 (Yes at Step S106), the mobile device 1 stores the image data and the position data included in the received data in the storage 9 (Step S107), and subsequently reads the map data 9E from the storage 9 (Step S108).

The mobile device 1 generates display data using the image data and the position data received from the mobile device 100 and the map data 9E (Step S109).

After generating the display data, the mobile device 1 outputs the display data generated at Step S109 to the display 2A (Step S110), and ends the processing.

As illustrated in FIG. 8, the mobile device 1 displays an image 50a corresponding to the display data generated at Step S109 on the display 2A. The image 50a includes a map M1, an object OB1, and an image G1. The mobile device 1 simultaneously displays the object OB1 representing the position of the mobile device 100 when the buzzer switch 113B is activated and the image G1 captured by the mobile device 100 when the buzzer switch 113B is activated, in a manner superimposed on the map M1, on the display 2A. The image 50a may include a representation indicating that the buzzer switch 113B is activated, the date and time when the buzzer switch 113B is activated, and an address indicating the position of the mobile device 100.

If, as a result of the determination, it is determined that the buzzer switch 113B is not operated at Step S101 (No at Step S101), the mobile device 100 repeats the determination at Step S101. When the processing is in an executable state, the mobile device 100 may repeatedly make the determination at Step S101.

If, as a result of the determination, it is determined that the data is not received from the mobile device 100 at Step S106 (No at Step S106), the mobile device 1 repeats the determination at Step S106. When the processing is in an executable state, the mobile device 1 may repeatedly make the determination at Step S106.

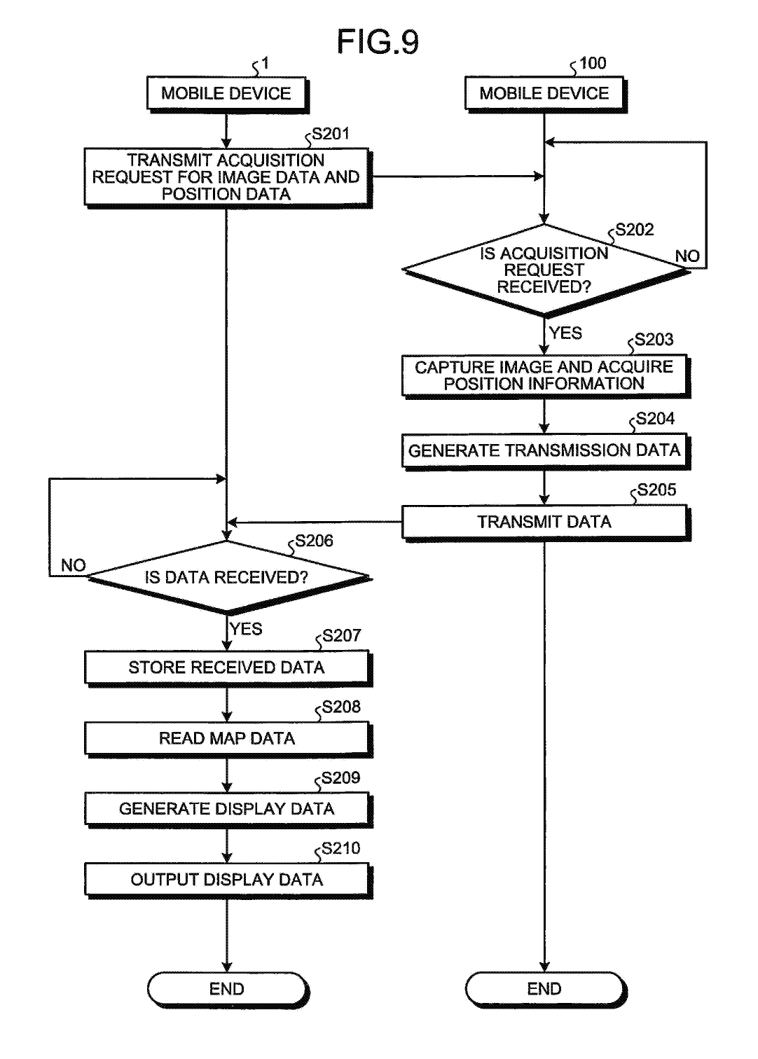

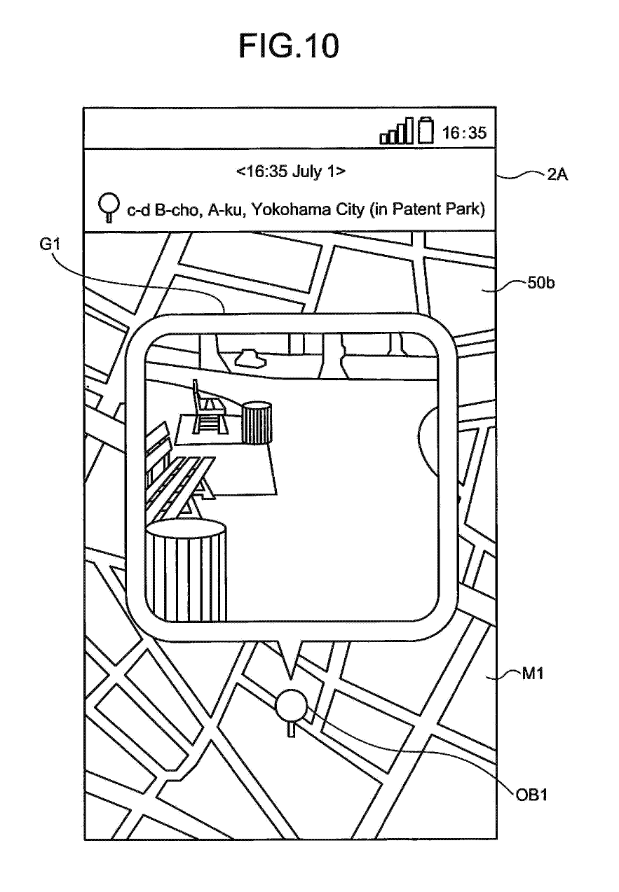

Another example of the processing according to the embodiments will be described using FIGS. 9 and 10. FIG. 9 is a diagram illustrating the other example of the processing according to the embodiments. FIG. 10 is a diagram illustrating another example of the display method of the image and the position information according to the embodiments. The processing illustrated in FIG. 9 is an example of the processing performed between the mobile device 100 and the mobile device 1 based on the request from the mobile device 1.

As illustrated in FIG. 9, the mobile device 1 transmits an acquisition request for image data and position data to the mobile device 100 (Step S201). The processing at Step S201 is performed, for example, in response to an operation of the user of the mobile device 1.

The mobile device 100 determines whether the acquisition request for image data and position data is received from the mobile device 1 (Step S202).

If, as a result of the determination, it is determined that the acquisition request is received (Yes at Step S202), the mobile device 100 captures an image and acquires position information (Step S203), and generates transmission data including the image data and the position information (Step S204).

The mobile device 100 transmits the transmission data generated at Step S204 to the mobile device 1 (Step S205), and ends the processing.

The mobile device 1 determines whether the data is received from the mobile device 100 (Step S206).

If, as a result of the determination, it is determined that the data is received from the mobile device 100 (Yes at Step S206), the mobile device 1 stores the image data and the position data included in the received data in the storage 9 (Step S207), and subsequently reads the map data 9E from the storage 9 (Step S208).

The mobile device 1 generates display data using the image data and the position data received from the mobile device 100 and the map data 9E (Step S209).

After generating the display data, the mobile device 1 outputs the display data generated at Step S209 to the display 2A (Step S210), and ends the processing.

As illustrated in FIG. 10, the mobile device 1 displays an image 50b corresponding to the display data generated at Step S209 on the display 2A. For convenience of description, the image 50b represents an example of an image when the position of the mobile device 100 is the same as that of the image 50a illustrated in FIG. 8. The image 50b includes the map M1, the object OB1, and the image G1. The mobile device 1 simultaneously displays the object OB1 representing the position of the mobile device 100 when the acquisition request is received from the mobile device 1 and the image G1 captured by the mobile device 100 when the acquisition request is received from the mobile device 1, in a manner superimposed on the map M1, on the display 2A. The image 50b may include the date and time of imaging on the mobile device 100 and the address indicating the position of the mobile device 100.

If, as a result of the determination, it is determined that the acquisition request is not received at Step S202 (No at Step S202), the mobile device 100 repeats the determination at Step S202. When the processing is in an executable state, the mobile device 100 may repeatedly make the determination at Step S202.

If, as a result of the determination, it is determined that the data is not received from the mobile device 100 at Step S206 (No at Step S206), the mobile device 1 repeats the determination at Step S206. When the processing is in an executable state, the mobile device 1 may repeatedly make the determination at Step S206.

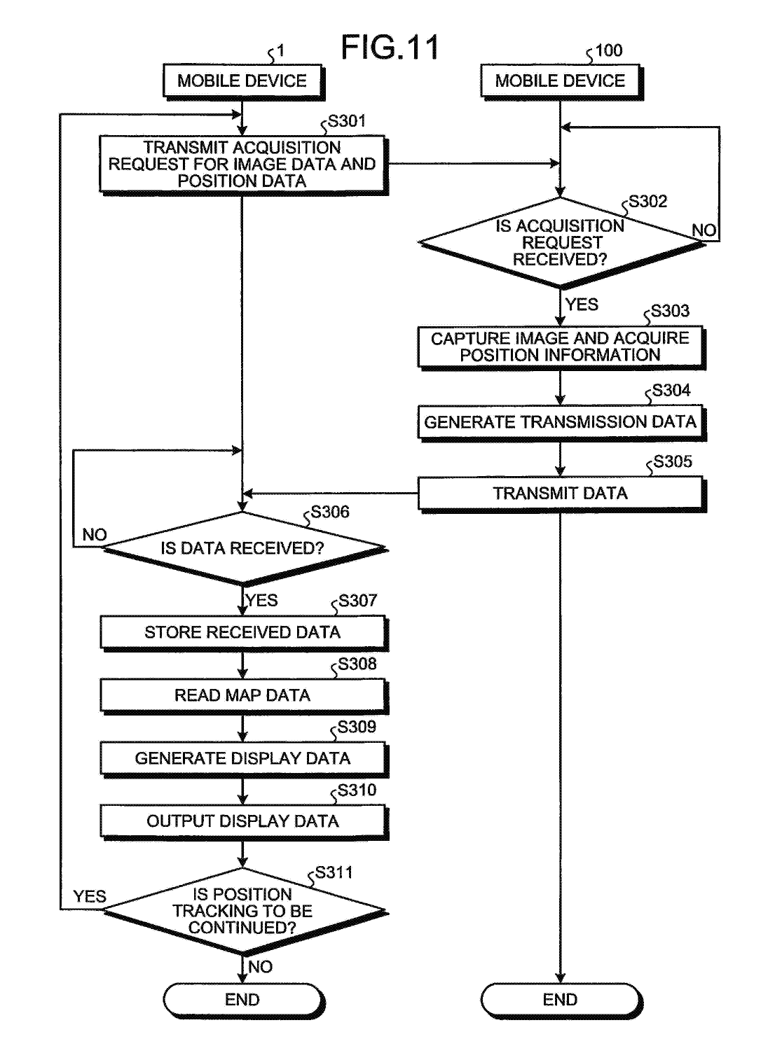

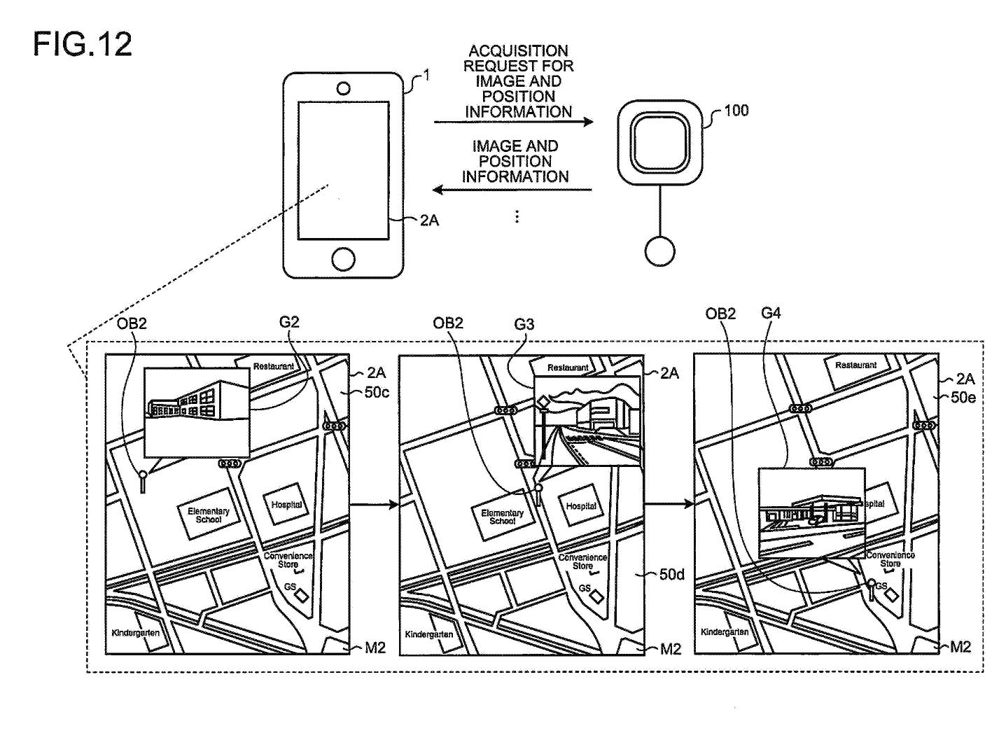

Still another example of the processing according to the embodiments will be described using FIGS. 11 and 12. FIG. 11 is a diagram illustrating the still other example of the processing according to the embodiments. FIG. 12 is a diagram illustrating still another example of the display method of images and position information according to the embodiments. The processing illustrated in FIG. 11 is an example of the processing performed between the mobile device 100 and the mobile device 1 based on repeated requests from the mobile device 1. The processing illustrated in FIG. 11 differs from the processing illustrated in FIG. 9 in the processing at Step S311 of the procedure.

As illustrated in FIG. 11, the mobile device 1 transmits an acquisition request for image data and position data to the mobile device 100 (Step S301).

The mobile device 100 determines whether the acquisition request for image data and position data is received from the mobile device 1 (Step S302).

If, as a result of the determination, it is determined that the acquisition request is received (Yes at Step S302), the mobile device 100 captures an image and acquires position information (Step S303), and generates transmission data including the image data and the position data (Step S304).

The mobile device 100 transmits the transmission data generated at Step S304 to the mobile device 1 (Step S305), and ends the processing.

The mobile device 1 determines whether the data is received from the mobile device 100 (Step S306).

If, as a result of the determination, it is determined that the data is received from the mobile device 100 (Yes at Step S306), the mobile device 1 stores the image data and the position data included in the received data in the storage 9 (Step S307), and subsequently reads the map data 9E from the storage 9 (Step S308).

The mobile device 1 generates display data using the image data and the position data received from the mobile device 100 and the map data 9E (Step S309).

After generating the display data, the mobile device 1 outputs the display data generated at Step S309 to the display 2A (Step S310).

After outputting the display data, the mobile device 1 determines whether to continue tracking the position of the mobile device 100 (Step S311).

If, as a result of the determination, it is determined to continue tracking the position of the mobile device 100 (Yes at Step S311), the mobile device 1 returns the processing to Step S301 of the procedure described above. In contrast, if, as a result of the determination, it is determined not to continue tracking the position of the mobile device 100 (No at Step S311), the mobile device 1 ends the processing.

As illustrated in FIG. 12, the mobile device 1 displays images 50c to 50e corresponding to the display data generated at Step S309 on the display 2A. The image 50c includes a map M2, an object OB2, and a captured image G2. The image 50d includes the map M2, the object OB2, and a captured image G3. The image 50e includes the map M2, the object OB2, and a captured image G4. The position of the object OB2 in each of the images 50c to 50e corresponds to the position of the user of the mobile device 100 at the time when the acquisition request is received from the mobile device 1. Each of the captured images G2 to G4 corresponds to the image captured by the mobile device 100 when the acquisition request is received from the mobile device 1. The mobile device 1 simultaneously displays the object OB2 representing the position of the mobile device 100 when the acquisition request is received from the mobile device 1 and the captured image G2, the captured image G3, or the captured image G4 captured by the mobile device 100 when the acquisition request is received from the mobile device 1, in a manner superimposed on the map M2, on the display 2A.

If, as a result of the determination, it is determined that the acquisition request is not received at Step S302 (No at Step S302), the mobile device 100 repeats the determination at Step S302. When the processing is in an executable state, the mobile device 100 may repeatedly make the determination at Step S302.

If, as a result of the determination, it is determined that the data is not received from the mobile device 100 at Step S306 (No at Step S306), the mobile device 1 repeats the determination at Step S306. When the processing is in an executable state, the mobile device 1 may repeatedly make the determination at Step S306.

Each of the images simultaneously displayed with the position of the mobile device 100 on the display 2A of the mobile device 1 by the processing illustrated in FIG. 11 may be a moving image, such as the live view image, linked to the position of the mobile device 100. This configuration allows the user of the mobile device 1 to continuously understand the situation of the user of the mobile device 100 changing with time.

In the several embodiments described above, in response to the activation of the crime prevention buzzer, the mobile device 100 can transmit the image captured at the time of the activation of the crime prevention buzzer and the position of the own device to the mobile device 1. Thus, in an emergency related to the crime prevention, the user of the mobile device 100 can provide the information for the user of the mobile device 1 to facilitate recognition of the situation of the user of the mobile device 100, to the user of the mobile device 1. In other words, the user of the mobile device 100 can inform the user of the mobile device 1 of the situation of the user of the mobile device 100 in an easy-to-understand manner by providing both the visual information capable of leading to recognition of the state of a real space and the position information. The mobile device 1 can simultaneously display the position of the mobile device 100 and the image captured by the mobile device 100 at the time of the activation of the crime prevention buzzer.

In the several embodiments described above, the mobile device 100 can transmit the image captured when the request is received from the mobile device 1 and the position of the own device to the mobile device 1, in response to the request from the mobile device 1. Thus, the user of the mobile device 1 can understand the situation of the user of the mobile device 100 as needed by the user of the mobile device 1. In other words, the user of the mobile device 1 can learn, from the user of the mobile device 100, the situation of the user of the mobile device 100 in an easy-to-understand manner by receiving both the visual information capable of leading to recognition of the state of the real space and the position information. The mobile device 1 can simultaneously display the position of the mobile device 100 and the image captured by the mobile device 100 as needed.

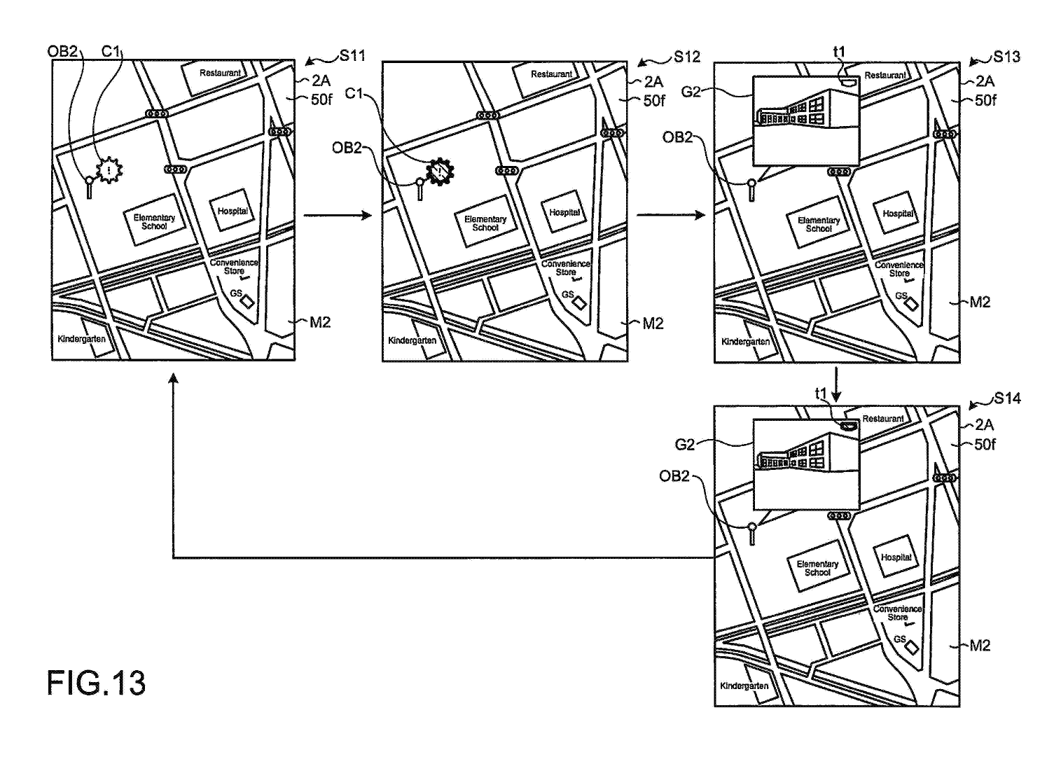

In the embodiments described above, an image displayed together with the position information on the mobile device 100 by the mobile device 1 on the display 2A may be displayed as an object freely switchable between display and non-display states in response to the user operations. The control program 9A can provide a function for displaying the image on the mobile device 100 as the object freely switchable between display and non-display states. By executing the control program 9A, the controller 10 can perform the processing of displaying the image on the mobile device 100 as the object freely switchable between display and non-display states. The following describes an example of displaying the image on the mobile device 100 as the object freely switchable between display and non-display states, using FIG. 13. FIG. 13 is a diagram illustrating still another example of the display method according to the embodiments. FIG. 13 differs from the image 50c of FIG. 12 in that the captured image G2 is displayed as the object freely switchable between display and non-display states.

As illustrated in FIG. 13, the mobile device 1 displays an image 50f including the object OB2 representing the position of the mobile device 100 and an object Cl corresponding the captured image G2 captured by the mobile device 100 in a manner superimposed on the map M2, on the display 2A (Step S11). If an operation to the object Cl by the user is detected (Step S12), the mobile device 1 presents and displays the captured image G2 corresponding to the object Cl in a speech balloon-like manner (Step S13). The captured image G2 includes a button t1 for restoring the captured image G2 to the object (to a hidden state) again. If an operation to the button t1 is detected (Step S14), the mobile device 1 restores the captured image G2 to the object Cl again, and returns the processing to the display processing at Step S11.

According to the example illustrated in FIG. 13, the user of the mobile device 100 can inform the user of the mobile device 1 of the situation of the user of the mobile device 100 in an easy-to-understand manner by transmitting the visual information in addition to the position information to the mobile device 1, and the user of the mobile device 1 can more accurately understand the position of the mobile device 1 by hiding the captured image to display the whole map according to the position information on the mobile device 1.

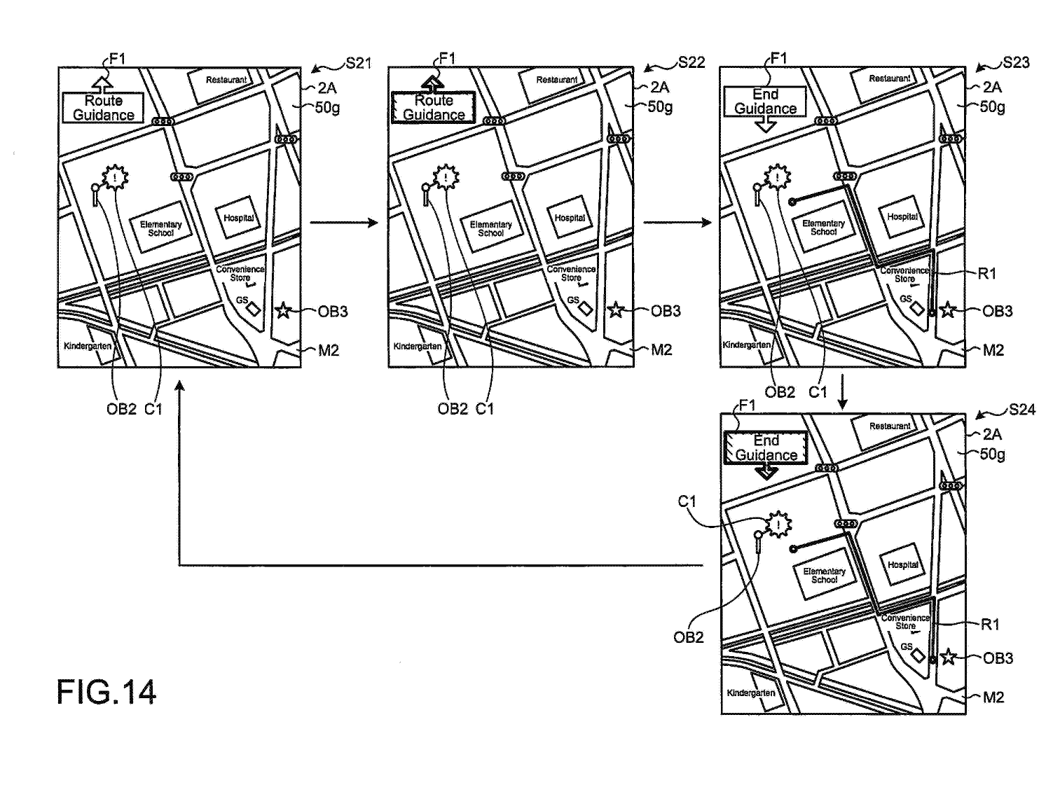

In the embodiments described above, when the mobile device 1 displays the image captured by the mobile device 100 and the position information thereon on the display 2A, the mobile device 1 may additionally display the position information on the own device. In addition, the mobile device 1 may display a route guidance to the mobile device 100 on the map. When the image captured by the mobile device 100 and the position information thereon are simultaneously displayed on the map, the control program 9A can provide a function for additionally displaying the position information on the own device and a function for performing the route guidance to the mobile device 100. The position information on the own device is measured based on a signal processed by the GPS receiver 19. By executing the control program 9A, the controller 10 can perform the processing of additionally displaying the position information on the own device and performing the route guidance to the mobile device 100, when the image captured by the mobile device 100 and the position information thereon are simultaneously displayed on the map. The following describes an outline of the route guidance processing performed by the mobile device 100, using FIG. 14. FIG. 14 is a diagram illustrating the outline of the route guidance processing according to the embodiments. FIG. 14 differs from the image 50f illustrated in FIG. 13 in including the position information on the mobile device 1 and an object for starting the route guidance.

As illustrated in FIG. 14, the mobile device 1 displays an image 50g including the object OB2 representing the position of the mobile device 100, the object Cl corresponding the captured image G2 captured by the mobile device 100, an object OB3 representing the position of the own device, and a button F1 for starting the route guidance in a manner superimposed on the map M2, on the display 2A (Step S21). If an operation to the button F1 by the user is detected (Step S22), the mobile device 1 starts the route guidance (Step S23). Specifically, after automatically setting a position corresponding to the position information on the own device as a starting point and a position corresponding to the latest position information on the mobile device 100 as a destination point, the mobile device 1 calculates the shortest route from the own device to the mobile device 100, and displays the calculated route on the map M2, on the display 2A. At Step S23, the mobile device 1 changes the denotation of the button F1, for example, from “Route Guidance” to “End Guidance” at the same time as the start of the route guidance. If an operation to the button F1 denoted as “End Guidance” is detected again (Step S24), the mobile device 1 ends the route guidance, deletes the display of the route from the map M2, and returns the processing to the display processing at Step S21.

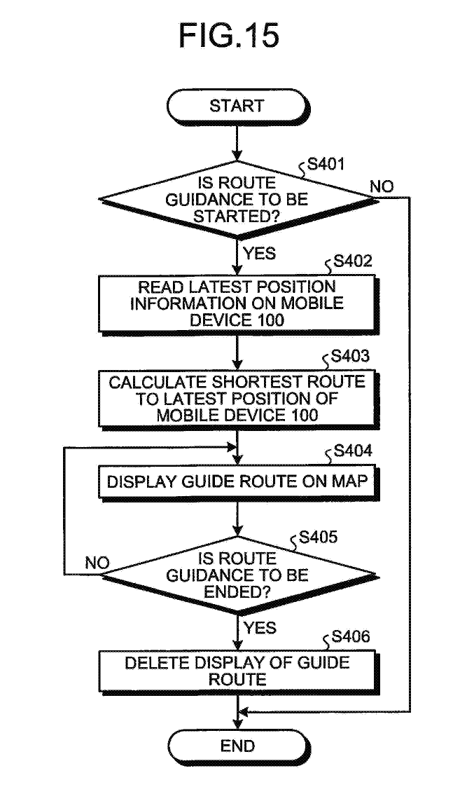

FIG. 15 is a flowchart illustrating a flow of the route guidance processing according to the embodiments. As illustrated in FIG. 15, the controller 10 determines whether to start the route guidance (Step S401). In other words, the controller 10 determines whether the button F1 illustrated in FIG. 14 is operated.

If, as a result of the determination, it is determined to start the route guidance (Yes at Step S401), the controller 10 reads the latest position information on the mobile device 100 from the storage 9 (Step S402).

The controller 10 calculates the shortest route from the own device to the mobile device 100 using the position information read at Step S402 (Step S403).

The controller 10 displays a guide route on the map (Step S404). The guide route is displayed by plotting the shortest route calculated at Step S403 on the map currently displayed on the display 2A.

The controller 10 determines whether to end the route guidance (Step S405). If, as a result of the determination, it is determined to not end the route guidance (No at Step S405), the controller 10 returns the processing to Step S404, and continues displaying the guide route.

In contrast, if the route guidance is to be ended (Yes at Step S405), the controller 10 deletes the display of the guide route (Step S406), and ends the processing illustrated in FIG. 15.

If, as a result of the determination, it is determined to not start the route guidance at Step S401 (No at Step S401), the controller 10 ends the processing illustrated in FIG. 15.

In the example illustrated in FIG. 14, when the mobile device 1 displays the image captured by the mobile device 100 and the position information thereon on the display 2A and displays, at the same time, the position information on the own device on the map, the mobile device 1 may automatically adjust the map scale so as to simultaneously plot the position information on the mobile device 100 and the position information on the own device on the map. When the mobile device 1 performs the route guidance, the mobile device 1 may display at least one of the captured image captured by the mobile device 100, and the guide route and the position information on the own device, on the map, without displaying the position information on the mobile device 100 on the display 2A. When the mobile device 1 performs the route guidance, the mobile device 1 may be capable of performing functions, such as setting of transportation means, including walking, a bicycle, an automobile, and an electric train, and display of a travel distance and time to reach the destination point, that are usually included in, for example, an application that performs the route guidance.

According to the example illustrated in FIGS. 14 and 15, the user of the mobile device 1 can understand the positional relation between the mobile device 100 and the own device while understanding the situation of the mobile device 100 by additionally displaying the position information on the own device when the image captured by the mobile device 100 and the position information thereon are simultaneously displayed on the map. Since the mobile device 1 performs the route guidance to the mobile device 100 when the mobile device 1 displays the image captured by the mobile device 100 on the map, the user of the mobile device 1 can travel to the position of the mobile device 100 while understanding the situation of the mobile device 100.

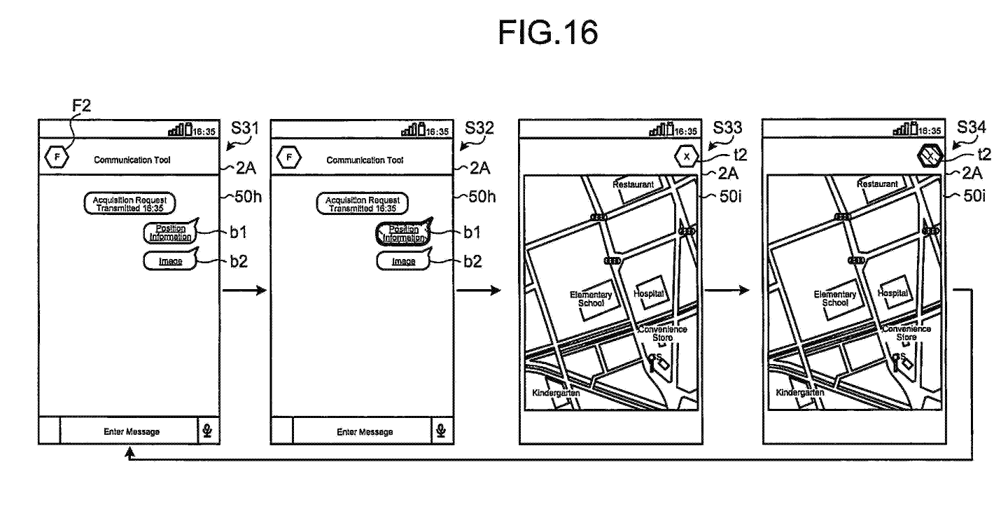

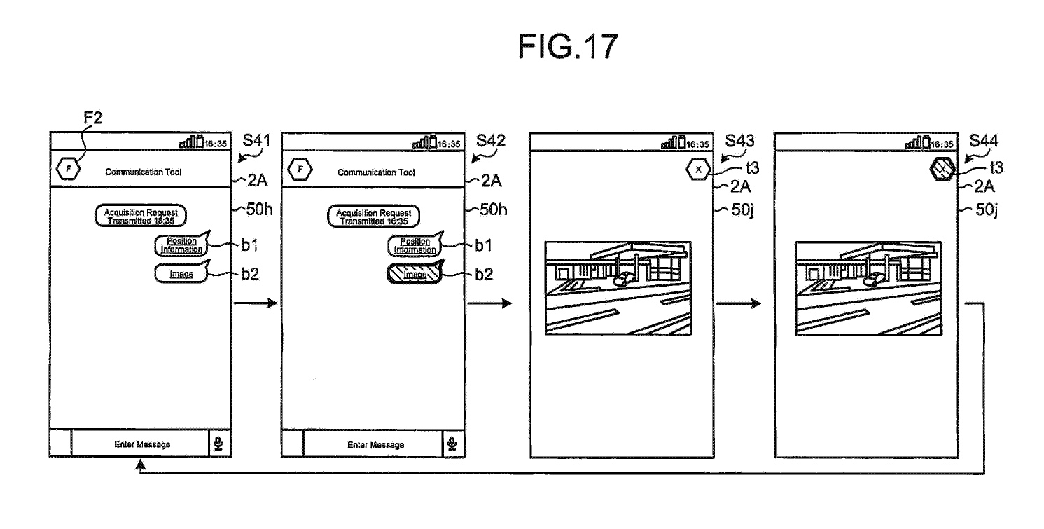

The display method (of, for example, FIGS. 8 and 10) described in the embodiments described above may be used on the execution screen of the communication tool that exchanges messages between the mobile device 1 and mobile device 100. When the mobile device 1 simultaneously displays the position of the mobile device 100 and the image captured by the mobile device 100, the position display and the image display may be performed as independent display operations. For example, the control program 9A can achieve such display by providing a function for displaying, in cooperation with the communication tool 9B, the image captured by the mobile device 100 and the position information displayed overlapping the map including the position corresponding to the position information on the mobile device 100, each as an independent massage, on the execution screen of the communication tool 9B displayed on the display 2A. In other words, the control program 9A can individually display the image captured by the mobile device 100 and the map displaying the position of the mobile device 100 in units of display when the messages are displayed on the execution screen of the communication tool 9B. The following describes other examples of the display method according to the embodiments, using FIGS. 16 and 17. FIGS. 16 and 17 are diagrams illustrating the other examples of the display method according to the embodiments.

FIG. 16 illustrates a method for displaying the position information on the execution screen of the communication tool 9B. As illustrated in FIG. 16, an execution screen 50h of the communication tool 9B displayed on the display 2A of the mobile device 1 individually displays a balloon b1 corresponding to the position information on the mobile device 100 and a balloon b2 corresponding to the captured image, in predetermined units of display of the communication tool 9B (Step S31). The balloon b1 is associated with the position information received from the mobile device 100 and stored in the storage 9 in a state capable of reading the position information. The balloon b2 is associated with the captured image received from the mobile device 100 and stored in the storage 9 in a state capable of reading the captured image. The execution screen 50h may include a button F2 for displaying a menu of the communication tool 9B. For example, the menu displayed by an operation to the button F2 may include a command for acquiring the position information on the mobile device 100.

If an operation to the balloon b1 is detected (Step S32), the mobile device 1 reads the position information associated with the balloon b1, and displays a window 50i on which the read position information is represented and displayed on the display 2A (Step S33). The window 50i includes a button t2 for closing the window 50i. If an operation to the button t2 is detected (Step S34), the mobile device 1 closes the window 50i, and returns the processing to the display processing at Step S31.

FIG. 17 illustrates a method for displaying the captured image on the execution screen of the communication tool 9B. As illustrated in FIG. 17, the execution screen 50h of the communication tool 9B displayed on the display 2A of the mobile device 1 individually displays the balloon b1 corresponding to the position information on the mobile device 100 and the balloon b2 corresponding to the captured image, in the predetermined units of display of the communication tool 9B (Step S41).

If an operation to the balloon b2 is detected (Step S42), the mobile device 1 reads the captured image associated with the balloon b2, and displays a window 50j on which the read captured image is represented and displayed on the display 2A (Step S43). The window 50j includes a button t3 for closing the window 50j. If an operation to the button t3 is detected (Step S44), the mobile device 1 closes the window 50j, and returns the processing to the display processing at Step S41.

In the examples illustrated in FIGS. 16 and 17, the execution screen 50h of the communication tool 9B may directly display the image captured by the mobile device 100 and the position information thereon, instead of displaying the balloon b1 and the balloon b2.

In the examples illustrated in FIGS. 16 and 17, the operation to the button t2 for closing the window 50i may be performed by a predetermined touch gesture. The same applies to the operation to the button t3 for closing the window 50j.

According to the examples illustrated in FIGS. 16 and 17, the user of the mobile device 1 can simultaneously check the visual information based on the image and the position information, for example, on the mobile device 1 having a limited display area for messages relative to the whole display 2A.

As described above, condition 1 includes that the predetermined request is transmitted to the mobile device 100 through the communication unit 6, and the mobile device 100 captures an image in response to the request. Also, condition 2 includes that a predetermined operation is performed to the mobile device 100, and the mobile device 100 captures the image in response to the operation.

In the embodiments described above, if the captured image simultaneously displayed on the display 2A together with the position information when the above-described condition 2 is satisfied is a still image, the mobile device 1 may simultaneously display the position information and a moving image on the display 2A when condition 1 is further satisfied. The control program 9A can provide a function for simultaneously displaying the position information and the moving image on the display 2A when condition 1 is further satisfied if the captured image simultaneously displayed on the display 2A together with the position information when the above-described condition 2 is satisfied is the still image. By executing the control program 9A, the controller 10 can perform the processing of simultaneously displaying the position information and the moving image on the display 2A when condition 1 is further satisfied if the captured image simultaneously displayed on the display 2A together with the position information when the above-described condition 2 is satisfied is the still image. With this configuration, if the user of the mobile device 1 needs further detailed information after viewing the still image captured by the mobile device 100, the user of the mobile device 1 can cause the mobile device 1 to acquire the moving image captured by the mobile device 100 as more detailed information than the image.

In the embodiments described above, if the captured image simultaneously displayed on the display 2A together with the position information when the above-described condition 1 is satisfied is a still image, the mobile device 1 may simultaneously display the position information and a moving image on the display 2A when condition 1 is satisfied again. The control program 9A can provide a function for simultaneously displaying the position information and the moving image on the display 2A when condition 1 is satisfied again if the captured image simultaneously displayed on the display 2A together with the position information when the above-described condition 1 is satisfied is the still image. By executing the control program 9A, the controller 10 can perform the processing of simultaneously displaying the position information and the moving image on the display 2A when condition 1 is satisfied again if the captured image simultaneously displayed on the display 2A together with the position information when the above-described condition 1 is satisfied is the still image. With this configuration, if the user of the mobile device 1 needs further detailed information after viewing the still image captured by the mobile device 100, the user of the mobile device 1 can cause the mobile device 1 to acquire the moving image captured by the mobile device 100 as more detailed information than the image.

In the embodiments described above, the mobile device 100 may continue capturing the image from when the above-described condition 2 is satisfied until the above-described condition 1 is satisfied, or from when the above-described condition 1 is satisfied until the above-described condition 1 is satisfied again.

In the embodiments described above, when the mobile device 1 simultaneously displays the image captured by the mobile device 100 and the position information thereon on the display 2A (refer, for example, to FIGS. 8, 10, 12, and 13), the mobile device 1 can display the position information (object representing the position of the mobile device 100) and the captured image in a manner adjusted in display positions at least so as not to overlap each other.

The characteristic embodiments have been described above to fully and clearly disclose the technique according to the accompanying claims. However, the accompanying claims should not be limited to the embodiments described above, and should be embodied by all modifications and alternative configurations that can be created by those skilled in the art within the scope of the fundamental matters described in this specification.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device comprising a communication unit, a display, and a controller, wherein
the controller is configured, if a predetermined condition is satisfied, to:
receive information including a captured image captured by another electronic device and latest position information on the other electronic device from the other electronic device through the communication unit, and
cause the display to simultaneously display the captured image and the position information on the display.

2. The electronic device according to claim 1, wherein the predetermined condition includes that a predetermined request is transmitted to the other electronic device through the communication unit, and that the other electronic device acquires the captured image in response to the request.

3. The electronic device according to claim 1, wherein the predetermined condition includes that a predetermined operation is performed to the other electronic device, and that the other electronic device acquires the captured image in response to the operation.

4. The electronic device according to claim 1, wherein
the captured image is a still image that is captured and then stored in the other electronic device, and
the controller is configured, if the predetermined condition is satisfied, to:
receive information including the still image and the position information from the other electronic device through the communication unit, and
cause the display to simultaneously display the still image and the position information on the display.

5. The electronic device according to claim 4, wherein
the controller is configured to:
receive the still image and the position information a plurality of times at predetermined intervals of time, and
cause the display to simultaneously display the still image and the position information on the display a plurality of times.

6. The electronic device according to claim 1, wherein
the controller is configured, if the predetermined condition is satisfied, to:
receive the information including the captured image and the position information from the other electronic device through the communication unit, and
cause the display to simultaneously display the captured image and the position information as a moving image and position information changing with time on the display.

7. The electronic device according to claim 1, wherein the controller is configured to cause the display to display the captured image and the position information in a manner superimposed on a map including a position corresponding to the position information on the display.

8. The electronic device according to claim 1, wherein the controller is configured to cause the display to display the captured image and the position information displayed overlapping a map including a position corresponding to the position information, each as an independent massage, on a message application screen displayed on the display.

9. An electronic device comprising an imager, a position information acquisition unit, a communication unit, and a controller, wherein
the controller is configured, if receiving a predetermined request from another electronic device through the communication unit, to:
cause the imager to capture an image, and
transmit information including the image and latest position information acquired by the position information acquisition unit to the other electronic device through the communication unit.

10. The electronic device according to claim 9, further comprising a display, wherein
the controller is configured to transmit the image, regardless of the shape of the display, as an image smaller in difference in ratio between vertical and horizontal sizes than that of a display included in the other electronic device.

11. A system comprising a first electronic device and a second electronic device, wherein
the first electronic device is configured to transmit information including a captured image and latest position information to the second electronic device if a predetermined condition is satisfied, and
the second electronic device is configured to simultaneously display the captured image and the latest position information if receiving the information including the captured image and the latest position information from the first electronic device.
